(19) United States
(12) Patent Application Publication
(10) Pub. No.: US 2011/0221914 A1
(43) Pub. Date: Sep. 15, 2011

(54) ELECTRONIC CAMERA

(75) Inventors: Toshiyasu SHINBO, Uji-shi (JP); Mitsuaki KUROKAWA, Toyonaka-shi (JP)

(73) Assignee: SANYO ELECTRIC CO., LTD., Osaka (JP)

(21) Appl. No.: 13/029,620

(22) Filed: Feb. 17, 2011

(30) Foreign Application Priority Data
Mar. 9, 2010 (JP) 2010-51281

(51) Int. Cl. H04N 5/228

(52) U.S. Cl. 348/208.2; 348/222.1; 348/E05.024

(57) ABSTRACT

An electronic camera includes an imaging device. An imaging device outputs a scene image produced on an imaging surface capturing a scene. A rotator performs a rotating process in a direction around an optical axis on the scene image outputted from the imaging device in response to a recording operation. A recorder records the scene image rotated by the rotator on a recording medium. A determiner determines a rotation of the imaging surface in the direction around the optical axis in response to the recording operation. An adjuster adjusts a rotation angle of the rotator to an angle which is different corresponding to a determined result of the determiner.

### CROSS REFERENCE OF RELATED APPLICATION

The disclosure of Japanese Patent Application No. 2010-51281, which was filed on Mar. 9, 2010, is incorporated herein by reference.

### BACKGROUND OF THE INVENTION

1. Field of the Invention

The present invention relates to an electronic camera. More particularly, the present invention relates to an electronic camera provided with an openable monitor portion on a side surface.

2. Description of the Related Art

According to one example of this type of apparatus, a motion of an imaging device is detected by using a camera-shake detecting sensor or a motion vector obtained from a video signal, and based on the motion detection result, an image stabilizing is performed by moving a cut out frame structure Bn (an effective photographing region) in a photographable maximum region.

However, in the above-described apparatus, in a case where a photographing is performed with inclining the imaging device in a manner of a camera shake being unrecognized, the recorded image becomes which is not based on a view point of a photographer, and thereby, visibility of the image may be deteriorated.

### SUMMARY OF THE INVENTION

An electronic camera according to the present invention, comprises: an imager which outputs a scene image produced on an imaging surface capturing a scene; a rotator which performs a rotating process in a direction around an optical axis on the scene image outputted from the imager in response to a recording operation; a recorder which records the scene image rotated by the rotator on a recording medium; a determiner which determines a rotation of the imaging surface in the direction around the optical axis in response to the recording operation; and an adjuster which adjusts a rotation angle of the rotator to an angle different corresponding to a determined result of the determiner.

An imaging control method according to the present invention is an imaging control method executed by an electronic camera provided with an imager which outputs a scene image produced on an imaging surface capturing a scene, comprises: a rotating step of performing a rotating process in a direction around an optical axis on the scene image outputted from the imager in response to a recording operation; a recording step of recording the scene image rotated by the rotating step on a recording medium; a determining step of determining a rotation of the imaging surface in the direction around the optical axis in response to the recording operation; and an adjusting step of adjusting a rotation angle of the rotating step to an angle different corresponding to a determined result of the determiner.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an allocation state of a cut-out area in a raw image area of the SDRAM;

FIG. 5 is a block diagram showing a configuration of a post-processing circuit applied to the embodiment in FIG. 2;

FIG. 6 (A) is an illustrative view showing one example of a posture of a digital video camera at a time of photographing;

FIG. 6 (B) is an illustrative view showing another example of the posture of the digital video camera at the time of photographing;

FIG. 7 (A) is an illustrative view showing one example of a photographed image outputted from an image sensor;

FIG. 7 (B) is an illustrative view showing one example of a recorded image written into a recording medium;

FIG. 7 (C) is an illustrative view showing one example of a display image displayed on an LCD monitor;

FIG. 8 (A) is an illustrative view showing another example of the photographed image outputted from the image sensor;

FIG. 8 (B) is an illustrative view showing another example of the recorded image written into the recording medium;

FIG. 8 (C) is an illustrative view showing another example of the display image displayed on the LCD monitor;

FIG. 9 (A) is an illustrative view showing one example of a transition state of a register in a pixel rearranging circuit at a time of reading YUV image data;

FIG. 9 (B) is an illustrative view showing one example of a state where rearranged-image data is outputted from the register in the pixel rearranging circuit;

FIG. 10 is a flowchart showing one portion of behavior of a CPU applied to the embodiment in FIG. 2;

FIG. 11 is a flowchart showing another portion of behavior of the CPU applied to the embodiment in FIG. 2;

FIG. 12 is a flowchart showing still another portion of behavior of the CPU applied to the embodiment in FIG. 2;

FIG. 13 (A) is an illustrative view showing still another example of the photographed image outputted from the image sensor;

FIG. 13 (B) is an illustrative view showing still another example of the recorded image written into the recording medium;

FIG. 13 (C) is an illustrative view showing yet another example of the recorded image written into the recording medium;

FIG. 14 (A) is an illustrative view showing yet another example of the photographed image outputted from the image sensor;

FIG. 14 (B) is an illustrative view showing another example of the recorded image written into the recording medium; and

FIG. 14 (C) is an illustrative view showing still another example of the recorded image written into the recording medium.

### DETAILED DESCRIPTION OF THE PREFERRED EMBODIMENTS

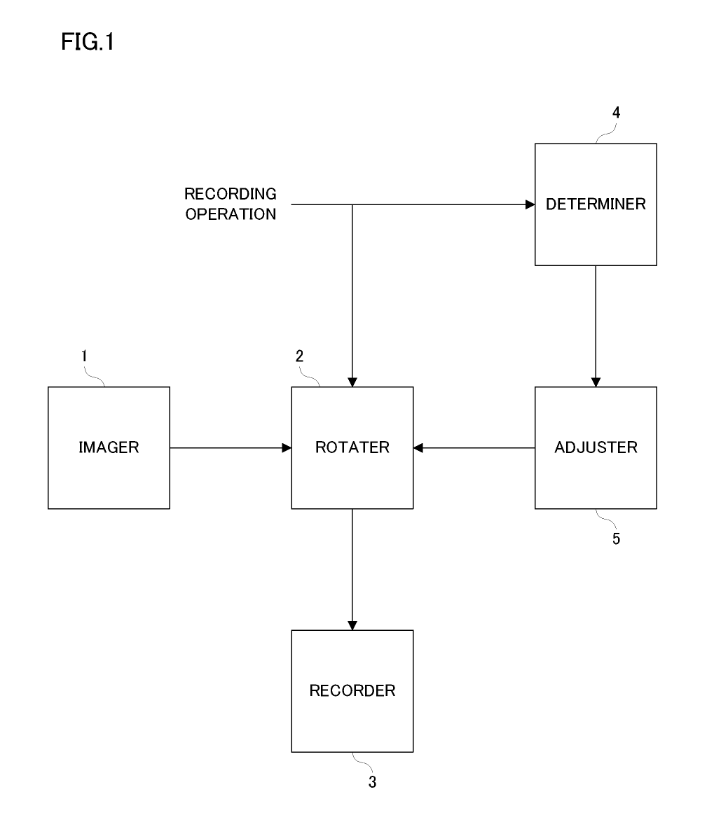

With reference to FIG. 1, an electronic camera of one embodiment of the present invention is basically configured as follows: An imaging device 1 outputs a scene image produced on an imaging surface capturing a scene. A rotator 2 performs a rotating process in a direction around an optical axis on the scene image outputted from the imaging device 1 in response to a recording operation. A recorder 3 records the scene image rotated by the rotator 2 on a recording medium. A determiner 4 determines a rotation of the imaging surface in the direction around the optical axis in response to the recording operation. An adjuster 5 adjusts a rotation angle of the rotator 2 to an angle which is different corresponding to a determined result of the determiner 4.

Thus, the scene image produced in response to the recording operation is recorded on the recording medium via the rotating process for the angle which is different corresponding to a rotation state of the imaging surface in the direction around the optical axis. Thereby, it becomes possible to improve visibility of a recorded image.

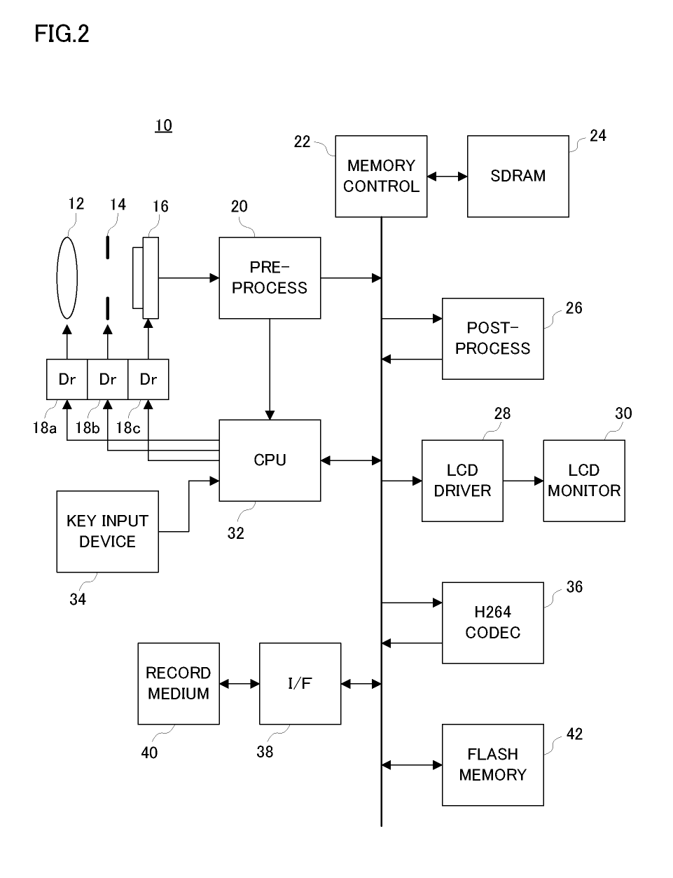

With reference to FIG. 2, a digital video camera 10 according to this embodiment includes a focus lens 12 and an aperture unit 14 respectively driven by drivers 18a and 18b. An optical image of a scene enters, with irradiation, an imaging surface of an image sensor 16 through these components. It is noted that an effective image area on the imaging surface has a resolution of horizontal 2560 pixels×vertical 1600 pixels.

The digital video camera 10 has an SDRAM 24 as a memory device. Each potion configuring the digital video camera 10 writes data into the SDRAM 24 or reads out the data accommodated in the SDRAM 24 by issuing an access request toward a memory control circuit 22. In the access request, identification of read (reading out) or write (writing) and a head address and a size of the objective data are described. In a case of a reading-out request for image data, after an acknowledgment signal is sent back from the memory control circuit 22 to a request source, a designated size of the image data which is memorized in a region continued from the head address described in the access request is read out. In a case of a writing request for the image data, after the acknowledgment signal is sent back from the memory control circuit 22 to the request source, the designated size of the image data is outputted toward the memory control circuit 22. Then, through the memory control circuit 22, the outputted image data is accommodated in the region which continues from the head address described in the access request.

When a power source is applied, under an imaging task, a CPU 32 starts up a driver 18c in order to execute a moving-image taking process. In response to a vertical synchronization signal Vsync generated at every 1/60th of a second, the driver 18c exposes the imaging surface and reads out the electric charges produced on the imaging surface in a non-interlaced scanning manner. From the image sensor 16, raw image data representing the scene is outputted at a frame rate of 60 fps.

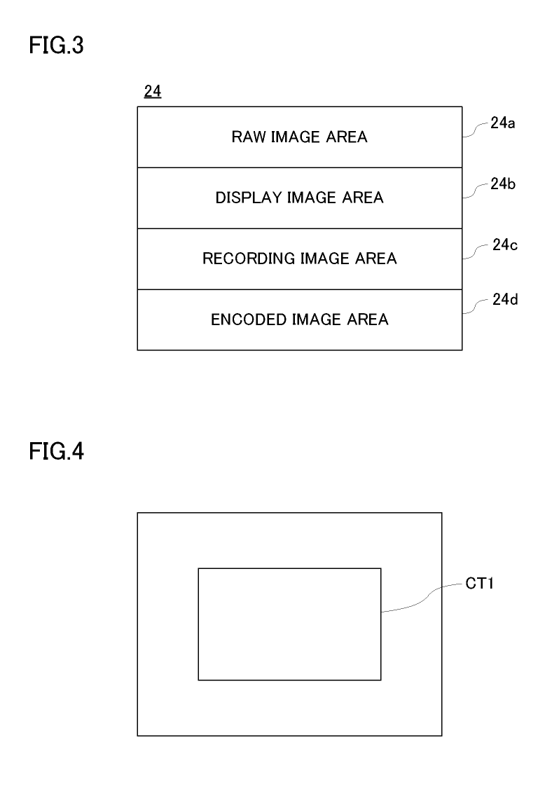

A pre-processing circuit 20 performs processes, such as digital clamp, pixel defect correction, and gain control, on the raw image data outputted from the image sensor 16. The raw image data on which such pre-processes are performed is written into a raw image area 24a (see FIG. 3) of the SDRAM 24 through the memory control circuit 22.

With reference to FIG. 4, a cut-out area CT1 is allocated to the raw image area 24a. The cut-out area CT1 has a resolution equivalent to horizontal 1920 pixels×vertical 1080 pixels (its aspect ratio is 16:9).

A post-processing circuit 26 burst accesses the raw image area 24a through the memory control circuit 22 so as to read out the raw image data corresponding to the cut-out area CT1 in the non-interlaced scanning manner. The read-out raw image data is subjected to processes such as color separation, white balance adjustment, YUV conversion and zoom operation, and as a result, display image data is created. The created display image data is outputted from the post-processing circuit 26, and is written into a display image area 24b (see FIG. 3) of the SDRAM 24 through the memory control circuit 22.

An LCD driver 28 repeatedly reads out the display image data accommodated in the display image area 24b, reduces the read-out display image data so as to be adapted to the resolution of an LCD monitor 30, and drives the LCD monitor 30 based on the reduced display image data. As a result, a real-time moving image (through image) representing the scene is displayed on a monitor screen.

Moreover, the pre-processing circuit 20 simply converts the raw image data into Y data, and applies the converted Y data to the CPU 32. The CPU 32 performs an AE process on the Y data under an imaging-condition adjusting task so as to calculate an appropriate EV value. An aperture amount and an exposure time period defining the calculated appropriate EV value are respectively set to the drivers 18b and 18c, and as a result, the brightness of the through image is moderately adjusted. Furthermore, the CPU 32 performs an AF process on a high-frequency component of the Y data when an AF start-up condition is satisfied. The focus lens 12 is placed at a focal point by the driver 18a, and as a result, the sharpness of the through image is continuously improved.

Moreover, in order to detect a motion of the imaging surface in a direction orthogonal to an optical axis, the CPU 32 executes a motion-detection process under a cut-out control task. When a detected motion is equivalent to a pan/tilt operation of the imaging surface, the CPU 32 suspends to move the cut-out area CT1, and when the detected motion is equivalent to a camera shake of the imaging surface, the CPU 32 moves the cut-out area CT1 so that the camera shake is compensated. This inhibits a through-image vibration resulting from the camera shake.

When a recording start operation is performed toward a key input device 34, the CPU 32 accesses a recording medium 40 through an I/F 38 under the imaging task so as to newly create an MP4 file onto the recording medium 40 (the created MP4file is opened).

Upon completion of the process for creating and opening the file, the CPU 32 starts up the post-processing circuit 26, an H264 codec 36, and the I/F 38 under the imaging task in order to start a recording process.

The post-processing circuit 26 burst accesses the raw image area 24a through the memory control circuit 22 so as to read out the raw image data corresponding to the cut-out area CT1 in the non-interlaced scanning manner. The read-out raw image data is subjected to processes such as the color separation, the white balance adjustment, the YUV conversion and pixel rearranging, and as a result, recording-image data is created. The created recording-image data is outputted from the post-processing circuit 26 and is written into a recording image area 24c (see FIG. 3) of the SDRAM 24 through the memory control circuit 22.

The H264 codec 36 reads out the image data accommodated in the recording image area 24c through the memory control circuit 22, compresses the read-out image data according to an MPEG-4 AVC/H.264 system, and writes the compressed image data into an encoded image area 24d (see FIG. 3) through the memory control circuit 22.

The I/F 38 reads out the compressed image data accommodated in the recording image area 24c through the memory control circuit 22, and writes the read-out compressed image data into the MP4 file newly created onto the recording medium 40.

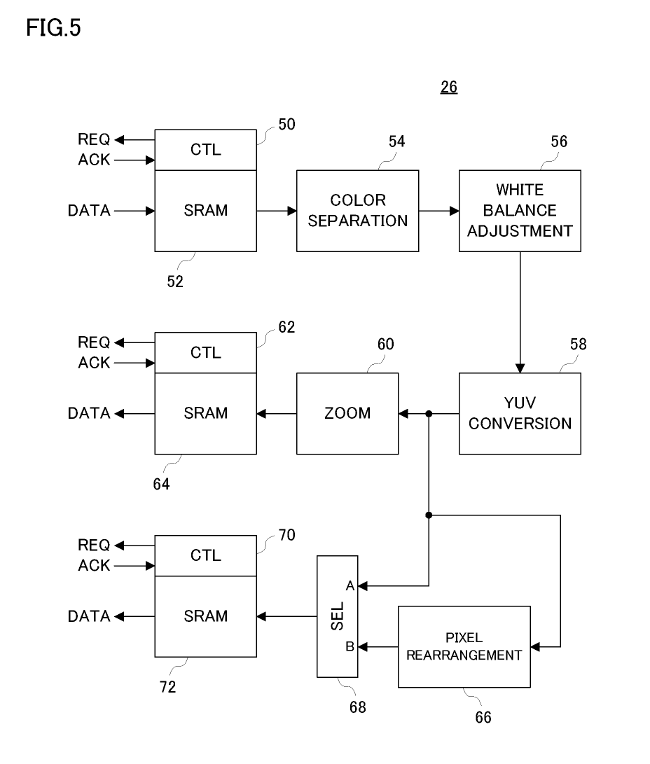

When a recording end operation is performed toward the key input device 34, the CPU 32 stops the post-processing circuit 26, the H264 codec 36, and the I/F 38 in order to end the recording process. Subsequently, the CPU 32 accesses the recording medium 40 through the I/F 38 so as to close the MP4 file that is a writing destination. The post-processing circuit 26 is configured as shown in FIG. 5. A controller 50 issues the reading-out request for the raw-image data toward the memory control circuit 22 each time an amount of data accommodated in an SRAM 52 falls below a threshold value.

A color separating circuit 54 performs a color separation process on the raw image data accommodated in the SRAM 52. As a result, RGB image data in which each pixel has all color information of R, G, and B is generated. A white balance adjusting circuit 56 adjusts a white balance of the RGB image data outputted from the color separating circuit 54, and a YUV converting circuit 58 converts the RGB image data outputted from the white balance adjusting circuit 56 into YUV image data.

A zoom circuit 60 performs a reduction zoom on the YUV image data outputted from the YUV converting circuit 58 so as to create display image data in which the resolution (the number of pixels) is reduced. The created display image data is written into an SRAM 64.

A controller 62 issues the writing request toward the memory control circuit 22 each time an amount of data accommodated in the SRAM 64 reaches the threshold value so as to read out and output a predetermined amount of the display image data from the SRAM 64 when the acknowledgment signal is sent back from an issuance destination.

A pixel rearranging circuit 66 performs the process of rearranging the pixel on the YUV image data outputted from the YUV converting circuit 58 so as to create rearranged image data based on an image in which the raw image is rotated. Moreover, the created rearranged-image data is outputted. A selector 68 selects any one of an input A and an input B corresponding to the set photographing mode. The YUV image data outputted from the YUV converting circuit 58 is applied to the input A, and the rearranged image data outputted from the pixel rearranging circuit 66 is applied to the input B. Data selected by the selector 68 is written into an SRAM 72 as the recording-image data.

A controller 70 issues the writing request toward the memory control circuit 22 each time an amount of data accommodated in the SRAM 72 reaches the threshold value so as to read out and output a predetermined amount of the recording-image data from the SRAM 72 when the acknowledgment signal is sent back from the issuance destination.

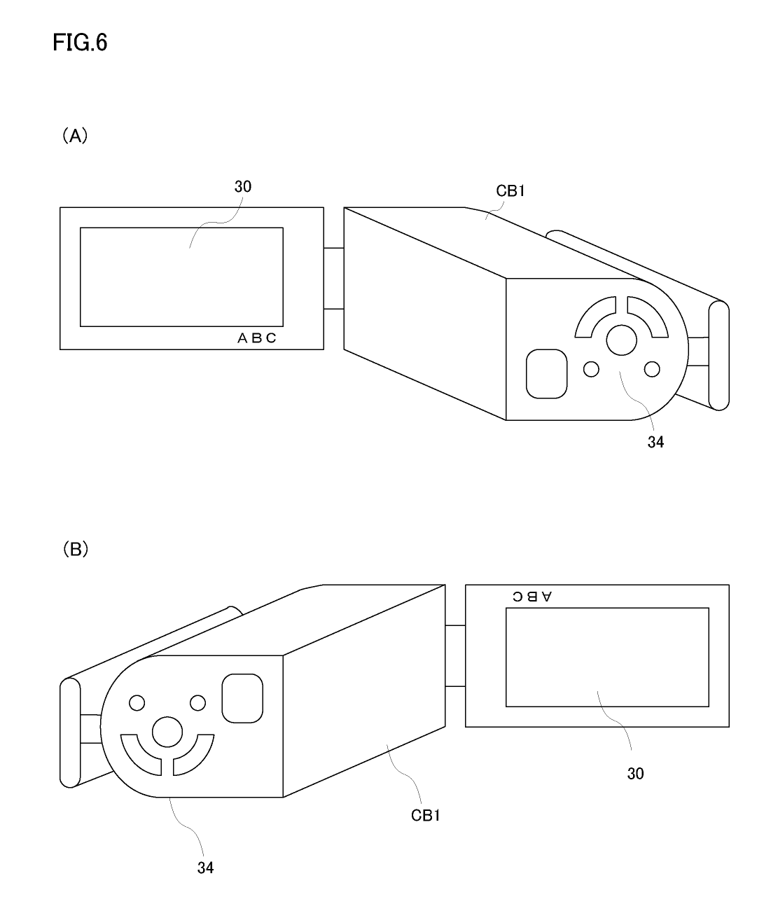

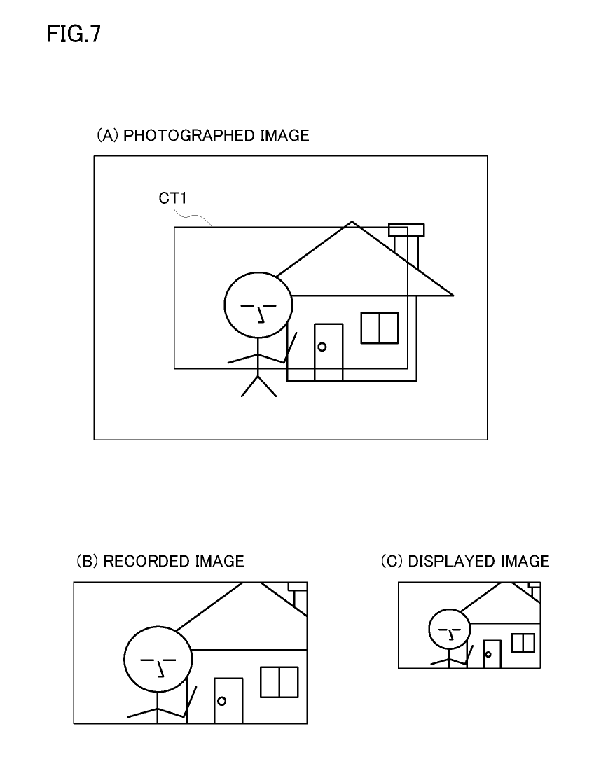

With reference to FIG. 6(A) and FIG. 6(B), the digital camera 10 installs the openable LCD monitor 30 on the left side of a video camera housing CB1. This is because it is easy to confirm the monitor by sight for a right-handed photographer when he photographs holding a video camera main body with his right hand that is the dominant hand. When the photographer holds the digital video camera 10 with his right hand, photographing is performed with a posture shown in FIG. 6(A). In this case, a recorded image shown in FIG. 7(B) is created corresponding to a photographed image shown in FIG. 7(A). Thus, the photographed image (FIG. 7(A)), the recorded image (FIG. 7(B)) and a displayed image (FIG. 7(C)) become the same image except that the resolution, etc. are different.

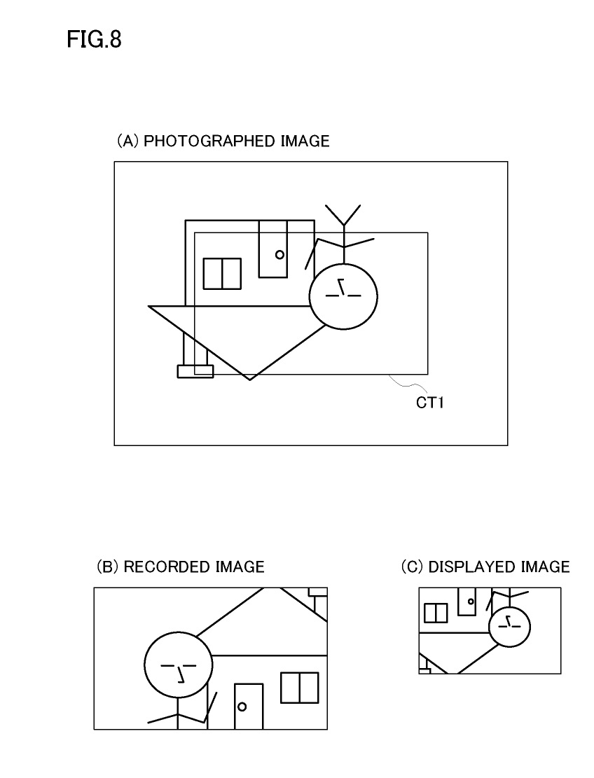

On the other hand, when a left-handed photographer, etc., holds the digital video camera 10 with his left hand, photographing is performed with a posture shown in FIG. 6(B). In this case, the digital video camera 10 is in a posture upside down, and therefore, a photographed image becomes that FIG. 7(A) is rotated by 180 degrees as shown in FIG. 8(A). Similarly, the displayed image becomes that FIG. 7(C) is rotated by 180 degrees as shown in FIG. 8(C). However, according to the recorded image, if the photographed image (FIG. 8(A)) is used as it is, it becomes very hard to see at a time of reproducing since the photographed image is not based on a view point of the photographer. Then, in this case, the digital video camera 10 according to the present invention creates a recorded image (FIG. 8(B)) based on the view point of the photographer by rotating the photographed image by 180 degrees. Details of the process are described as follows.

The digital video camera 10 has two photographing modes, i.e., a right-handed photographing mode and a left-handed photographing mode, and any one of photographing modes is set by an operation of the photographer toward the key input device 34. In a case where the digital video camera 10 is held in an upright posture by the right-handed photographer, etc., the photographer selects the right-handed photographing mode. In a case where the digital video camera 10 is held in upside down by the left-handed photographer, etc., the photographer selects the left-handed photographing mode. From the raw image area 24a of the SDRAM 24, the raw image data is read out from a head position (an upper left position) toward a tail end position (a lower right position) of the raw image data by each eight pixels, and is subjected to processes such as the color separation, the white balance adjustment and the YUV conversion. The selector 68 selects the input A if the photographing mode is set to the right-handed photographing mode (see FIG. 5). Therefore, the YUV image data outputted from the YUV conversion circuit 58 is inputted.

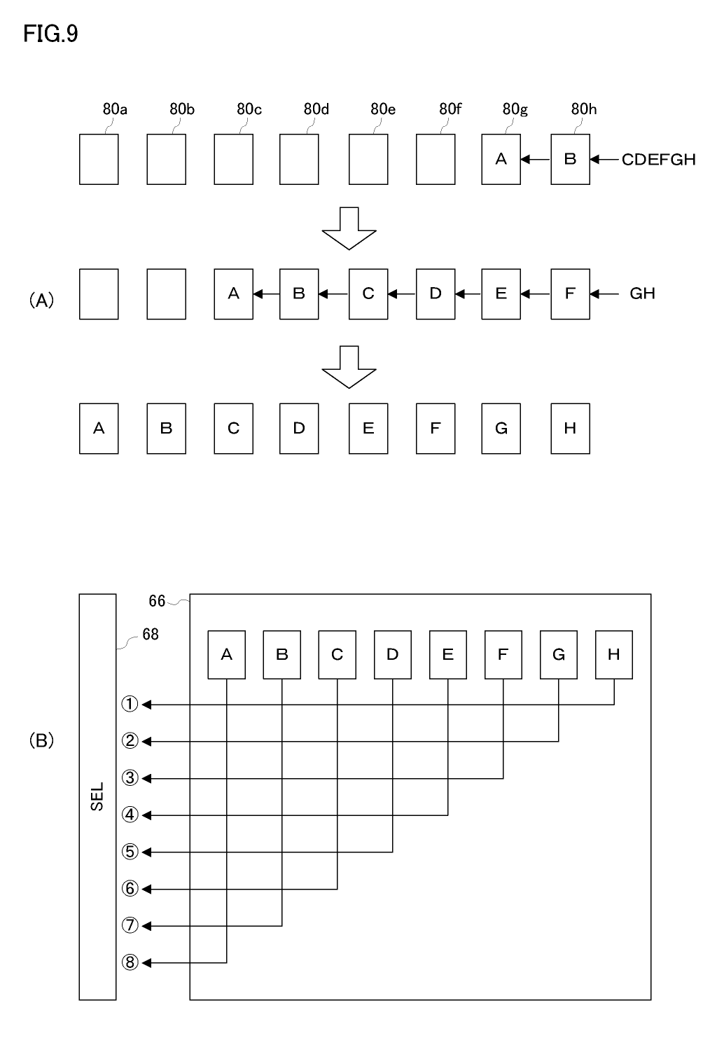

Similarly to the time of reading out the raw image data from the raw image area 24a, the recording image data is written into the SRAM 72 as a pixel configuring the recorded image data, from the upper left position toward the lower right position by each eight pixels. The created recorded image data is subjected to the compressing process described above, and is written into the MP4 file in the recording medium 40. With reference to FIG. 9(A), the pixel rearranging circuit 66 reads the YUV image data outputted from the YUV converting circuit 58 into one's own shift registers 80a to 80h by each eight pixels. Then, with reference to FIG. 9(B), in order of being newly read, the pixel is outputted toward the selector 68 as the rearranged image data. The pixel read firstly is outputted lastly. That is, the pixel is outputted in a LIFO (Last In First Out) system.

In a case where the photographing mode is set to the left-handed photographing mode, the selector 68 selects the input B (see FIG. 5). Therefore, the rearranged image data outputted from the pixel rearranging circuit 66 is selected by the selector 68.

In a case where the input B is selected by the selector 68, the controller 70 controls so that the rearranged image data is written into the SRAM 72 by changing a scanning start position from the time of reading out the raw image data from the raw image area 24a. The eight pixels outputted from the pixel rearranging circuit 66 firstly are scanned from the upper left position of the photographed image, however, these are changed so as to be scanned from the eighth position counting from the lower right position to the left position of the image. The eight pixels which are read subsequently are changed so as to be scanned from the 16th position counting from the lower right position to the left position of the image.

Thereafter, the pixels are respectively changed so as to be scanned from the eight by Nth (N:1, 2, 3, . . . ) position counting from the lower right position to the left position of the image by each eight pixels. Upon completion of writing the lowest column of the image, writing of the second column from the bottom is started from the right side similarly to the above described process. Thereafter, the process is similarly performed until writing the top column. The created recorded image data is subjected to the compressing process described above, and written into the MP4 file in the recording medium 40.

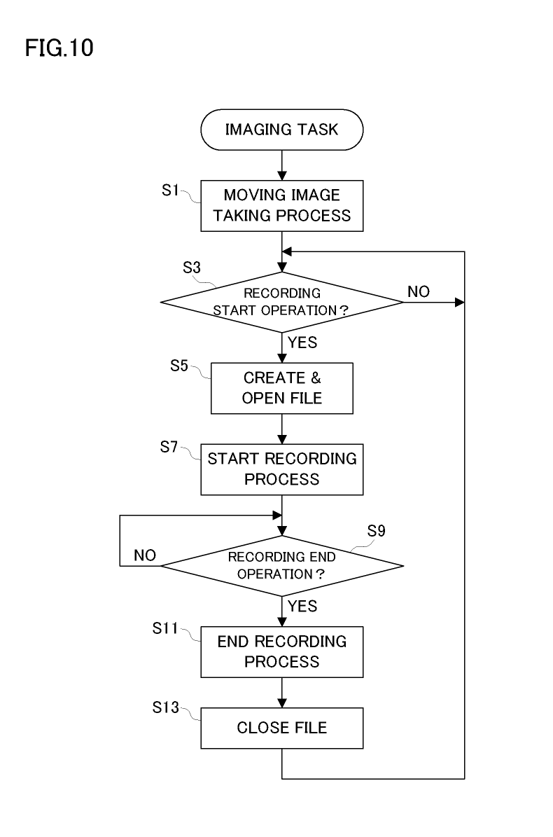

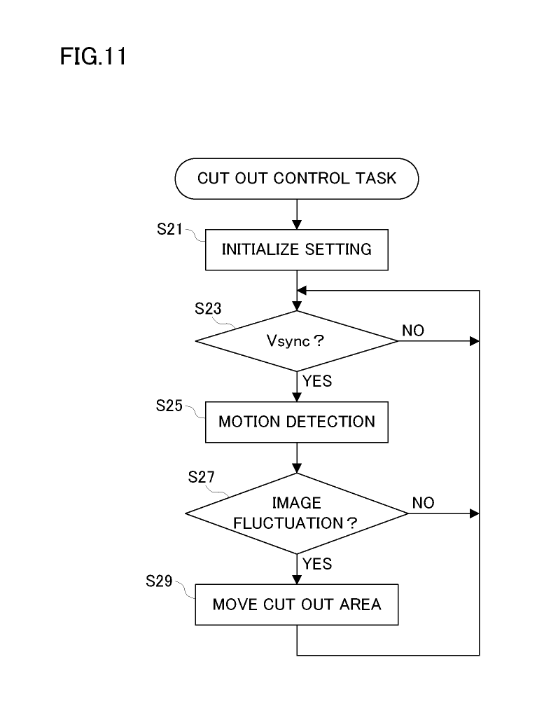

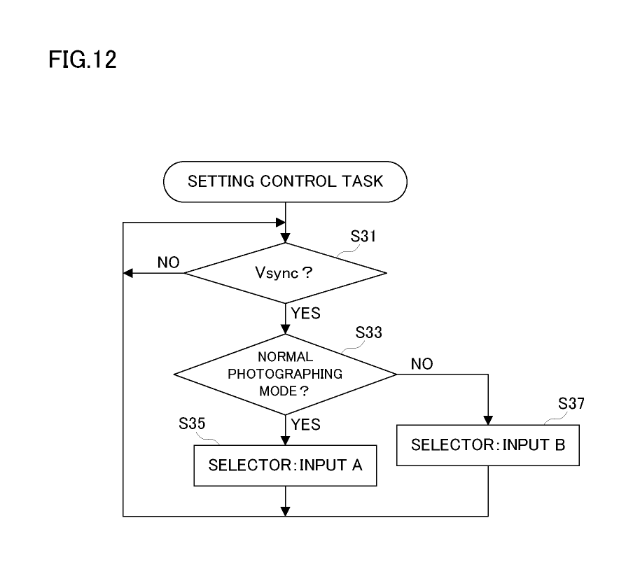

The CPU 36 executes a plurality of tasks including the imaging task shown in FIG. 10, the cut-out control task shown in FIG. 11, and a setting control task shown in FIG. 12, in a parallel manner. It is noted that control programs corresponding to these tasks are memorized in a flash memory 42.

With reference to FIG. 10, in a step S1, the moving-image taking process is executed. Thereby, the through image is displayed on the LCD monitor 30. In a step S3, it is repeatedly determined whether or not the recording start operation is performed, and when a determined result is updated from NO to YES, the process advances to a step S5. In the step S5, the recording medium 40 is accessed through the I/F 38 so as to newly create the MP4 file in the opened state onto the recording medium 40. In a step S7, the post-processing circuit 26, the H264 codec 36 and the I/F 38 are started up in order to start the recording process.

The post-processing circuit 26 reads out a partial raw image data belonging to the cut-out area CT1 through the memory control circuit 22, and performs the processes such as the color separation, the white balance adjustment, the YUV conversion and pixel rearranging so as to create the recording image data, based on the read-out raw image data. Then, the created image data is written into the recording image area 24c through the memory control circuit 22.

The H264 codec 36 reads out the image data accommodated in the recording image area 24c through the memory control circuit 22, compresses the read-out image data according to the MPEG-4 AVC/H.264 system, and writes the compressed image data into the encoded image area 24d through the memory control circuit 22.

The I/F 38 reads out the compressed image data accommodated in the recording image area 24c through the memory control circuit 22, and writes the read-out compressed image data into the MP4 file created in the step S5.

In a step S9, it is determined whether or not the recording end operation is performed. When a determined result is updated from NO to YES, the process advances to a step S11 and then stops the post-processing circuit 26, the H264 codec 36, and the I/F 38 in order to end the recording process. In a step S13, the recording medium 40 is accessed through the I/F 38 so as to close the MP4 file in the opened state. Upon completion of closing the file, the process returns to the step S3.

With reference to FIG. 11, in a step S21, a disposition of the cut-out area CT1 is initialized, and in a step S23, it is determined whether or not the vertical synchronization signal Vsync is generated. When a determined result is updated from NO to YES, the motion-detection process referring to the Y data is executed in a step S25. In a step S27, it is determined whether or not the motion of the imaging surface detected by the motion-detection process is equivalent to the camera shake, and when a determined result is NO, the process directly returns to the step S23. On the other hand, when YES is determined in the step S27, the cut-out area CT1 is moved in a step S29 so that the detected motion of the imaging surface is compensated, and thereafter, the process returns to the step S23.

With reference to FIG. 12, in a step S31, it is determined whether or not the vertical synchronization signal Vsync is generated. When a determined result is updated from NO to YES, in a step S33, it is determined whether or not the right-handed photographing mode is set. When a determined result is YES, the selector 68 selects the input A in a step S35, and thereafter, the process returns to the step S31. When the determined result is NO, the selector 68 selects the input B in a step S37, and thereafter, the process returns to the step S31.

As can be seen from the above-described explanation, the image sensor 16 outputs the scene image produced on the imaging surface capturing the scene. The post-processing circuit 26 performs the rotating process in the direction around the optical axis on the scene image outputted from the image sensor 16 in response to the recording operation. The I/F 38 records the scene image rotated by the post-processing circuit 26 on the recording medium 40. The CPU 32 determines the rotation of the imaging surface in the direction around the optical axis in response to the recording operation. Moreover, the CPU 32 adjusts the rotation angle of the post-processing circuit 26 to the angle which is different corresponding to the determined result.

Thus, the scene image produced in response to the recording operation is recorded on the recording medium via the rotating process for the angle which is different corresponding to the rotation state of the imaging surface in the direction around the optical axis. Thereby, it becomes possible to improve the visibility of the recorded image.

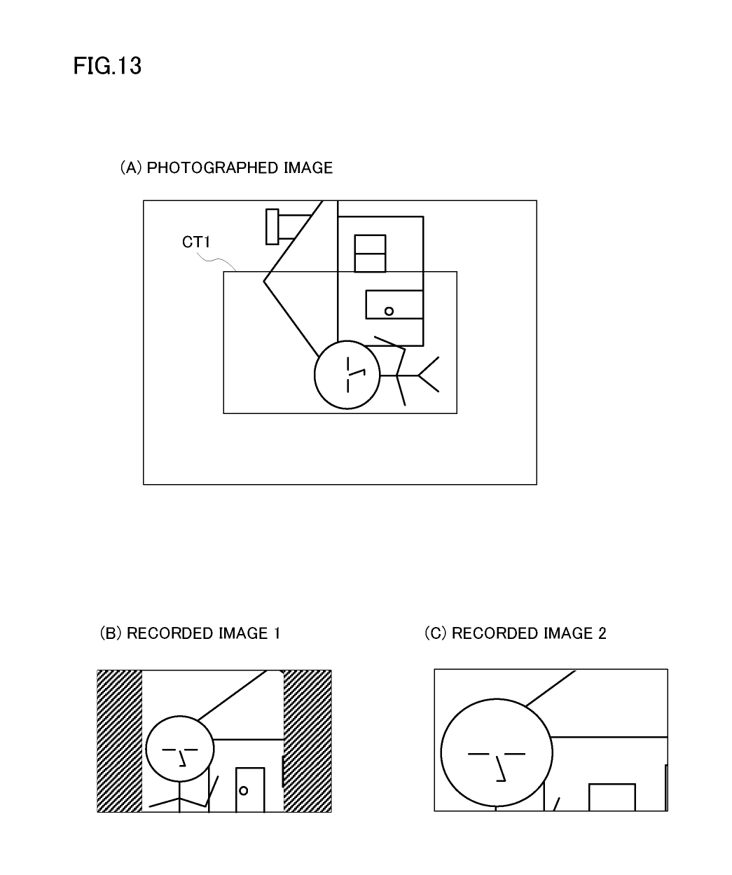

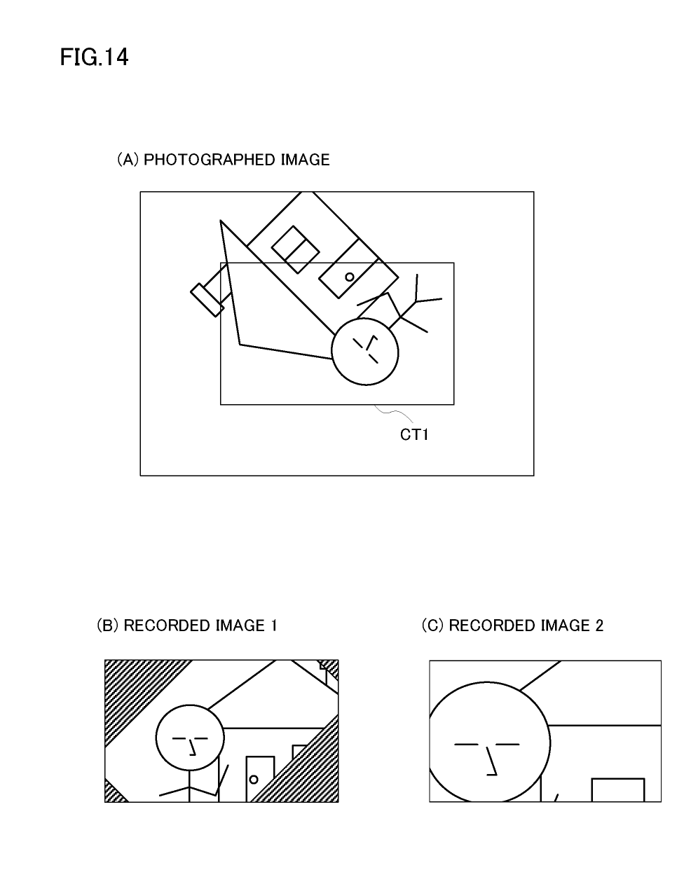

It is noted that, in this embodiment, the photographed image photographed by holding the digital video camera 10 upside down is rotated by 180 degrees as the recorded image. However, it is possible to adapt the present invention to a case of photographing by inclining the digital video camera 10 at an arbitrary angle. For example, in a case where the photographer holds the digital video camera 10 by inclining at 90 degrees from the upright posture to the right direction around the optical axis, the photographed image becomes as shown in FIG. 13(A). In this case, the recorded image shown in FIG. 13(B) is created by rotating the photographed image at 90 degrees to the right. Since the recorded image is created by rotating the image corresponding to the cut-out area CT1, the pixel becomes insufficient to maintain the aspect ratio, and the either side end of the recorded image having the insufficient pixel is subjected to a black-out process. Moreover, in a case where the blacked out portion is desired not to generate, etc., the image shown in FIG. 13(C) may be created by zooming in after performing such as a linear interpolation process. Moreover, in a case where the left-handed photographer, etc., holds the digital video camera 10 by inclining at 135 degrees from the upright posture to the right direction around the optical axis, the photographed image becomes as shown in FIG. 14(A). Similarly, the recorded image shown in FIG. 14(B) is created by rotating the image corresponding to the cut-out area CT1. Otherwise, the image shown in FIG. 14(C) may be created by the zoom in process.

Moreover, whether the recording medium 40 is an internal memory or an external memory of the digital video camera 10, it is possible to adapt the present invention to the both cases. Furthermore, it is possible to adapt the present invention to a case where the recording medium 40 is installed in a device different from the digital video camera 10. In this case, encoded image data, etc. may be transmitted from the digital video camera 10 by wired or wireless communications.

Moreover, in this embodiment, the present invention is described by using a digital video camera, however, it is possible to adapt the present invention to a digital still camera.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which outputs a scene image produced on an imaging surface capturing a scene;
a rotator which performs a rotating process in a direction around an optical axis on the scene image outputted from said imager in response to a recording operation;
a recorder which records the scene image rotated by said rotator on a recording medium;
a determiner which determines a rotation of said imaging surface in the direction around the optical axis in response to the recording operation; and
an adjuster which adjusts a rotation angle of said rotator to an angle different corresponding to a determined result of said determiner.

2. An electronic camera according to claim 1, wherein said imager repeatedly outputs the scene image, said recorder repeatedly records the scene image, and said adjuster maintains a common angle in a period during which said recorder executes a recording process.

3. An electronic camera according to claim 2, wherein said rotator includes a cut-out processor which cuts out a partial scene image belonging to a cut-out area out of the scene image outputted from said imager and a cut-out image rotator which rotates the scene image cut out by said cut-out processor.

4. An electronic camera according to claim 3, further comprising:
a detector which detects a motion of said imaging surface in a direction orthogonal to the optical axis; and
a mover which moves the cut-out area in a direction in which the motion detected by said detector is compensated.

5. An electronic camera according to claim 1, further comprising an acceptor which accepts a selection operation of selecting any one of a plurality of imaging modes respectively corresponding to a plurality of rotation angles in the direction around the optical axis, wherein said determiner executes a determining process with reference to an imaging mode selected by the selection operation.

6. An electronic camera according to claim 5, wherein the plurality of imaging modes include a first photographing mode for a right-handed photographer and a second photographing mode for a left-handed photographer, and said adjuster executes an angle adjustment by each 180 degrees.

7. An electronic camera according to claim 1, wherein the angle adjusted by said adjuster is equivalent to the rotation angle of said imaging surface in the direction around the optical axis.

8. An electronic camera according to claim 1, further comprising a reproducer which reproduces the scene image outputted from said imager in a common manner irrespective of the rotation of said imaging surface in the direction around the optical axis.

9. An imaging control method executed by an electronic camera provided with an imager which outputs a scene image produced on an imaging surface capturing a scene, the imaging control method comprising:
a rotating step of performing a rotating process in a direction around an optical axis on the scene image outputted from said imager in response to a recording operation;
a recording step of recording the scene image rotated by said rotating step on a recording medium;
a determining step of determining a rotation of said imaging surface in the direction around the optical axis in response to the recording operation; and
an adjusting step of adjusting a rotation angle of said rotating step to an angle different corresponding to a determined result of said determiner.
